(19) United States
(12) Patent Application Publication
(10) Pub. No.: US 2021/0287040 A1
(43) Pub. Date: Sep. 16, 2021

(54) TRAINING SYSTEM AND PROCESSES FOR OBJECTS TO BE CLASSIFIED

(71) Applicant: Fares AL-QUNAIEER, Riyadh (SA)

(72) Inventor: Fares AL-QUNAIEER, Riyadh (SA)

(21) Appl. No.: 16/819,898

(22) Filed: Mar. 16, 2020

(51) Int. Cl. G06K 9/62; G06N 20/20; G06K 9/46; G06K 9/32

(52) U.S. Cl. CPC G06K 9/6256; G06N 20/20; G06K 9/6267; G06K 9/6212; G06K 9/3233; G06K 9/46

(57) ABSTRACT

The present disclosure relates to a training system and, more particularly, to a method and system for training objects to be classified and related processes. The processes includes: extracting, using a computing device, features of a plurality of objects; training, using the computing device, a machine learning model with selected ones of the extracted features; building, using the computing device, a final machine learning model of the selected features after all of the plurality of objects for training are captured; and performing, using the computing device, an action on subsequent objects based on the trained final machine learning model.

### TECHNICAL FIELD

The present disclosure relates to a training system that can be taught by an operator and, more particularly, to a method and system for training objects to be classified and related processes.

### BACKGROUND

Classification models in embedded systems are used in many situations, such as attaching them to robots and machineries, such as in factories and distribution centers. The training of these systems is performed off-site, which requires high computation, and the more images and complex models (such as deep learning) used, the more increase in computation is required. Also, once trained, the system is brought on-site to perform its functions; however, in this deployment stage, the training may not have been sufficient, or software updates may be needed. To provide such, it is again necessary to develop the training off-site or develop software patches off-site, both of which are costly, timely and which results in an inefficient use of the system, itself.

### SUMMARY

In a first aspect of the present disclosure, a method comprises: extracting, using a computing device, features of a plurality of objects; training, using the computing device, machine learning models with selected ones of the extracted features; building, using the computing device, a final machine learning model of the selected features after all of the plurality of objects for training are captured; and performing, using the computing device, an action on subsequent objects based on the trained final machine learning model.

In a further aspect of the present disclosure, there is a system which comprises a processor, a computer readable memory, one or more computer readable storage media, and program instructions collectively stored on the one or more computer readable storage media, the program instructions executable to: receive captured images, data, and features of a plurality of objects from a sensor; extract selected features from the captured images; train a machine learning model with the selected captured and extracted features; build a final machine learning model of the selected features after training from the plurality of objects is completed; and perform an action on subsequent objects based on the trained final machine learning model.

### BRIEF DESCRIPTION OF THE DRAWINGS

The present disclosure is described in the detailed description which follows, in reference to the noted plurality of drawings by way of non-limiting examples of exemplary embodiments of the present disclosure.

FIG. 1A shows an overview of the training system in accordance with aspects of the present disclosure.

FIG. 1B shows an overview of a fixed line scan camera implemented in the system in accordance with aspects of the present disclosure.

FIG. 1C shows an overview of a fixed area scan camera implemented in the system in accordance with aspects of the present disclosure.

FIG. 1D shows an overview of a mobile line scan camera implemented in the system in accordance with aspects of the present disclosure.

FIG. 1E shows an overview of a mobile area scan camera implemented in the system in accordance with aspects of the present disclosure.

FIG. 2 shows an exemplary computing environment in accordance with aspects of the present disclosure.

FIG. 3 shows a block diagram using a batch training process in accordance with aspects of the present disclosure.

FIG. 4 depicts an exemplary flow using a batch training process with a fixed camera in accordance with aspects of the present disclosure.

FIG. 5 depicts an exemplary flow using a batch training process with a moving camera in accordance with aspects of the present disclosure.

FIG. 6 shows a block diagram using a mixed training process in accordance with aspects of the present disclosure.

FIG. 7 depicts an exemplary flow using a mixed training process with a fixed camera in accordance with aspects of the present disclosure.

FIG. 8 depicts an exemplary flow using a mixed training process with a moving camera in accordance with aspects of the present disclosure.

### DETAILED DESCRIPTION

The present disclosure relates to a training system and, more particularly, to a method and system for training on objects to be classified and related processes. In accordance with aspects of the present disclosure, the system for training can be implemented with an on-site teachable or trainable classification machine implemented using machine learning and computer vision, both of which are used to train on objects to be classified by the systems. Advantageously, the approach described herein will greatly speed up the development and installation of classification systems, such as sorting machines, as the training can be performed directly by the user of the machine, on-site.

In more specific embodiments, the present disclosure is directed to systems and processes that can be used to capture training data, label them, and perform training on objects using machine learning models, which use the captured data to produce classification models for object classification. Advantageously, the system can be trained by the user, themselves, on-site. So, by implementing the processes described herein, it is possible to train on objects, on site, with different classifications of objects. After the classification is provided, some action can be taken on the object, e.g., sorting, classifying, counting or determining some other physical characteristics.

For example, typical processes of training machine learning models for classification of physical objects consists of training and testing/deployment phases, where training is conducted off-site, and performed by data scientists or machine learning researchers. In contrast, the systems and processes described herein allow training and modeling on-site, and can be used with any user (i.e., a user that does not have any background in machine learning). The systems and processes allow for live validation, where after finishing the training phase, a validation phase is conducted to check the results on new objects that were not previously seen. Based on the results, the user might decide to add more training examples or to stop training and switch to production mode. The training can be conducted by grouping similar objects in batches (e.g., batch training) and performing the training on them, or by putting all items into a mixed group (e.g., mixed training) and manually labeling these mixed items (objects). This can be used with any classification tasks, such as classifying fruits, bottles, defected parts, etc. In embodiments, one or more features of the objects can be used to classify the objects.

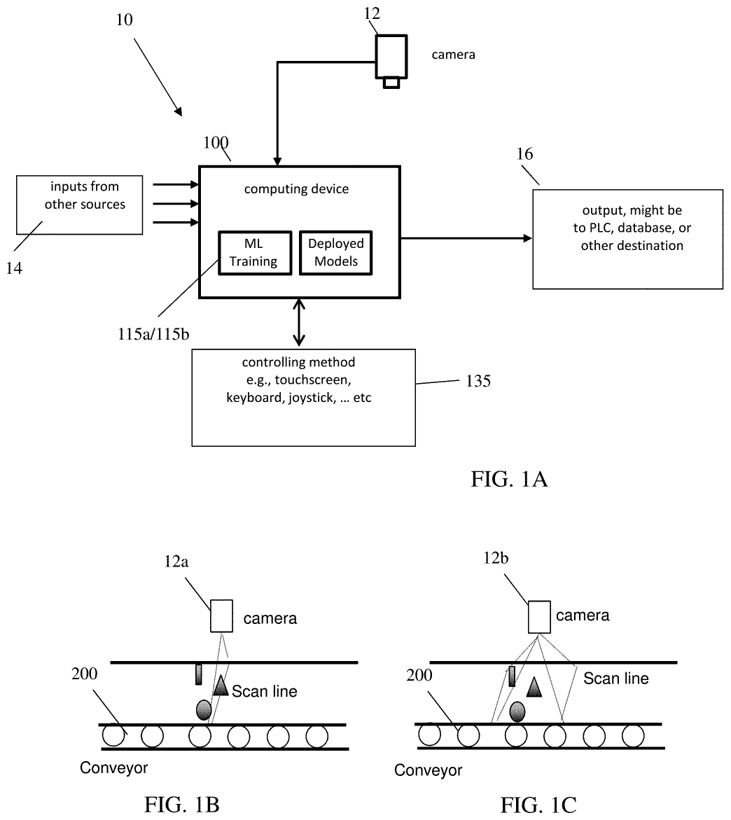

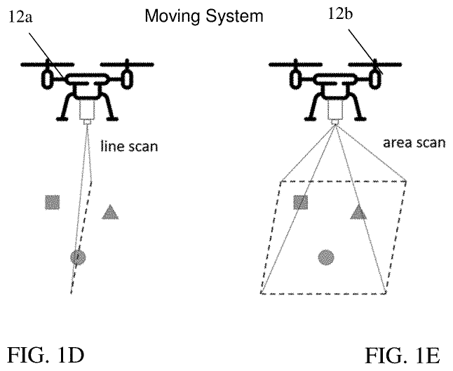

FIG. 1A shows an overview of the system in accordance with aspects of the present disclosure. In particular, the system 10 includes hardware parts and software for training and classification of objects. The system 10 includes a vision system 12 and, in embodiments, other input data sources 14. The vision system 12 can be various types of image capturing devices, including, e.g., gray scale cameras, color cameras, multi-spectral cameras, hyper-spectral cameras, thermal cameras, X ray imaging, ultrasound imaging, and any other imaging devices and modalities. In embodiments, cameras can be line scan, area scan, or point scan cameras, 2D scan or higher dimensional scanners and/or point cloud through 3d scanning sensors including LIDAR. The other input data sources 14 can be scales (weight), distance sensors, spectrometers, any other sensor types capable of detecting a characteristic of a physical object, and external sources of data about the objects and the environment. In embodiments, information obtained from the vision system 12 and, in embodiments, other input data sources 14, can include images, size, aspect ratio, color, reflectance, perimeter, texture, weight, temperature, humidity, material composition, point cloud, or other desired characteristic of the objects which can be used for categorizing these objects at a later stage. It should be understood that the images and/or data can be captured using a single camera, multiple cameras, a single sensor or multiple sensors, or combinations thereof.

Still referring to FIG. 1A, the information obtained from the vision system 12 and, in embodiments, other input data sources 14 is provided to a computing device or system 100. The computing system 100 includes machine learning modules and training modules 115a/115b, which can be used for training purposes to deploy trained models to an output 16. As described herein, the output 16 of the computing system 100 can be used to do various things, such as controlling devices or actuators (e.g., sorting machine, robotic arms, air pumps, etc.), saving results to a database, or triggering other actions, either physical or programmatic, and also either for a local system or external systems. In embodiments, at the training phase, objects can be detected and segmented from background before classifying them using various algorithms as described herein.

FIGS. 1B and 1C show the use of a fixed camera to capture object information (e.g., characteristics of the object) on a conveyor or other system 200; whereas, FIGS. 1D and 1E show the use of a moving camera to capture object information (e.g., characteristics of the object). In embodiments, the conveyor system 200 can also be representative of a sorting machine. Other situations might arise for fix camera scenario, as fixing the system above streets, or rivers, or any path in which there are moving objects to classify, all of which are represented at reference numeral 200. It should be understood by those of skill in the art that there are many applications for a fixed camera or sensor system, other than just sorting on a conveyor. By way of some examples, a fixed system can include: (i) inspection on conveyor to classify objects, such as parts' defects and fruits' grades, etc.; (ii) a fixed sensor or camera above a street to classify moving vehicles (e.g., cars, buses, trucks, motorcycles, etc.); (iii) a fixed sensor or camera above some point over a river to classify flowing objects (e.g., boats, animals or birds, debris or plants, etc.); and (iv) a fixed sensor or camera under moving objects, e.g., for classifying flying airplanes, birds, drones, etc. Another example is using a fixed system (e.g., camera or sensor) with a fixed object. An application is object monitoring and classifying its state, if the state is altered (e.g., heated objects through friction captured by thermal camera or thermal sensor), the system can provide an alert or turn off the monitored device or provide commands to another system.

It is also noted that the moving body that the system is attached to is not limited to drones as illustrated here, but is can be any vehicle, drone, or moving robot (bi-pedal, 4, 6, or 8 legged robots, robots on tires, robotic arm, etc.). As should be understood by those of skill in the art, the above are examples of the moving system, where additional applications are contemplated in which the classification device is attached on a moving body to make the classification on fixed objects. By way of some examples, a moving system can include: (i) attach the system on a drone and fly it above a field to classify crops such as, e.g., crops types, ripeness, and health; (ii) attach the system on a vehicle robot (e.g., on tires), that go through a field to identify weeds and remove them; (iii) attach the system on a front of moving car/truck and to classify road defects while driving (e.g., holes and cracks), or to identify garbage on the street; (iv) attach the system on a moving robotic arm that deals with objects (e.g., sorting or assembling), to classify them with the device and deal with them accordingly. It is also contemplated that there are cases in which the system (e.g., sensor and/or camera) is attached to a moving body and the objects to be classified are also moving. Some examples include: (i) the system is attached to a car while driving and classify other cars either moving or standing, e.g., used on a police car; (ii) the system might be attached under a fishing boat to classify fish that swim under it. In this latter example (ii), it is possible to classify either if there is any fish (e.g., fish or no fish) or classify fish by their type (e.g., salmon, etc.).

In embodiments, both the fixed camera and moving camera implementations can be a point scan, line scan camera 12a (FIG. 1B and FIG. 1D), an area scan camera 12b (FIG. 1C and FIG. 1E), or other scanning technologies in more dimensions, such as 3d scanning and depth scanning. As should be understood by those of ordinary skill in the art, an area scan camera provides a fixed resolution, which image is in a defined area; whereas, a line scan builds images using a single pixel row at a time as the object passes through the line with a linear motion. The moving camera can be implemented with a drone, for example. In all of these implementations, the objects can be used for training, using a mixed training process; although batch training is also contemplated herein.

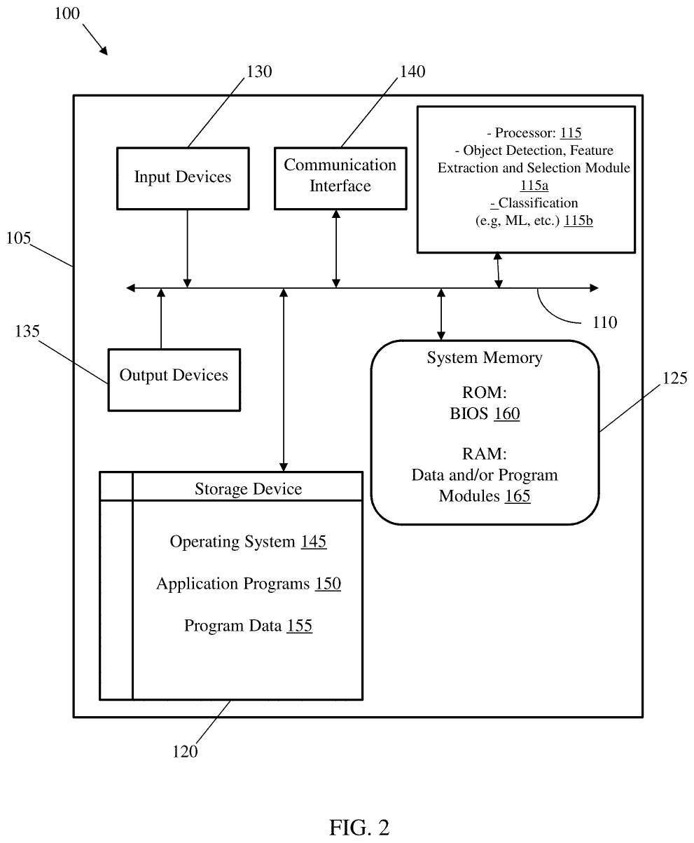

FIG. 2 is an illustrative architecture of a computing system 100 implemented as embodiments of the present disclosure. The computing system 100 is only one example of a suitable computing system and is not intended to suggest any limitation as to the scope of use or functionality of the present disclosure. Also, computing system 100 should not be interpreted as having any dependency or requirement relating to any one or combination of components illustrated in the computing system 100.

As shown in FIG. 2, the computing system 100 includes a computing device 105. The computing device 105 can be resident on a network infrastructure such as local network, remote network, or within a cloud environment, or may be a separate independent computing device (e.g., an edge computing device, PC, or workstation). The computing device 105 may include a bus 110, a processor 115, a storage device 120, a system memory (hardware device) 125, one or more input devices 130, one or more output devices 135, and a communication interface 140. The bus 110 permits communication among the components of the computing device 105. The bus 110 may be any of several types of bus structures including a memory bus or memory controller, a peripheral bus, and a local bus using any of a variety of bus architectures to provide one or more wired or wireless communication links or paths for transferring data and/or power to, from, or between various other components of the computing device 105.

The processor 115 may be one or more conventional processors or microprocessors that include any processing circuitry operative to interpret and execute computer readable program instructions, such as program instructions for controlling the operation and performance of one or more of the various other components of the computing device 105. The program instructions are also executable to provide the functionality of the system including, e.g., detection, segmentation, features extraction and selection, and classification, directly on an edge device, on a device in the local network, or on a remote device in a remote network or on the cloud (each one of which can be representative of the computing infrastructure of FIG. 2). By way of another example, the program instructions are executable to directly switch between training and deployment of an operation mode, to immediately be used after training. In further embodiments, the computing infrastructure can be a handheld device (e.g., phone or tablet) that can contain the system or is part of the system. For example, the a camera, sensors, storage, processing, and computation units, can be gathered in one enclosure (e.g., handheld device or other single unit as depicted in FIG. 2) or developed into separate modules that are connected within a same location or distributed into many locations.

Many types of processors can be used, e.g., Central Processing Unit (CPU), Graphics Processing Unit (GPU), AI accelerators, Microcontrollers, Field Programmable Gate Arrays (FPGA), or any other Application Specific Integrated Circuit (ASIC). In embodiments, the processor 115 interprets and executes the processes, steps, functions, and/or operations of the present disclosure, which may be operatively implemented by the computer readable program instructions. By way of illustration, the processor 115 includes a detection and feature extraction and selection module 115a and machine learning and training module 115b, used to train and deploy the models, e.g. train, validate, and classify objects, as described in more detail below.

In embodiments, the processor 115 may receive input signals from one or more input devices 130 and/or drive output signals through one or more output devices 135. The input devices 130 may be, for example, a keyboard or touch sensitive user interface (UI) or any of the sensors described with respect to FIGS. 1A-1E. The output devices 135 can be, for example, any display device, printer, etc., as further described below.

Still referring to FIG. 2, the storage device 120 may include removable/non-removable, volatile/non-volatile computer readable media, which is non-transitory media such as magnetic and/or optical recording media and their corresponding drives. The drives and their associated computer readable media provide for storage of computer readable program instructions, data structures, program modules and other data for operation of the computing device 105 and training machine learning models. In embodiments, the storage device 120 may store operating system 145, application programs 150, and program data 155 in accordance with aspects of the present disclosure.

The system memory 125 may include one or more storage mediums, which is non-transitory media such as flash memory, permanent memory such as read-only memory (“ROM”), semi-permanent memory such as random access memory (“RAM”), any other suitable type of storage component, or any combination thereof. In some embodiments, an input/output system 160 (BIOS) including the basic routines that help to transfer information between the various other components of computing device 105, such as during start-up, may be stored in the ROM. Additionally, data and/or program modules 165, such as at least a portion of operating system 145, application programs 150, and/or program data 155, that are accessible to and/or presently being operated on by processor 115 may be contained in the RAM.

The one or more input devices 130 may include one or more mechanisms that permit an operator to input information to computing device 105, such as, but not limited to, a touch pad, dial, click wheel, scroll wheel, touch screen, one or more buttons (e.g., a keyboard), mouse, game controller, track ball, microphone, camera, proximity sensor, light detector, motion sensors, biometric sensor, or any of the sensors already described herein (e.g., as shown and described with respect to FIGS. 1A-1E) and combinations thereof. The one or more output devices 135 may include one or more mechanisms that output information to an operator, such as, but not limited to, audio speakers, headphones, audio line-outs, visual displays, antennas, infrared ports, tactile feedback, actuators, other computing devices, databases, printers, or combinations thereof.

The communication interface 140 may include any transceiver-like mechanism (e.g., a network interface, a network adapter, a modem, cellular network (such as LTE, 2G, 3G, 4G, and 5G), or combinations thereof) that enables computing device 105 to communicate with remote devices or systems, such as a mobile device or other computing devices such as, for example, a server in a networked environment, e.g., local network, remote network, or cloud environment. For example, the computing device 105 may be connected to remote devices or systems via one or more local area networks (LAN) and/or one or more wide area networks (WAN) using the communication interface 140, either wired or wireless. In addition, the system can use other types of connections, such as firewire, parallel port, serial port, PS/2 port, USB port (any version of it), and thunderbolt port.

As discussed herein, the computing system 100 may be configured and trained to provide a model for the objects which are train upon. The model can then be used to classify subsequent objects that are detected by the sensors. In particular, the computing device 105 may perform tasks (e.g., process, steps, methods and/or functionality) in response to the processor 115 executing program instructions contained in a computer readable medium, such as system memory 125. The program instructions may be read into system memory 125 from another computer readable medium, such as data storage device 120, or from another device via the communication interface 140 or a server within a local or remote network, or within a cloud environment.

By way of more specific example and using the computing system 100 described herein, a training phase can be conducted as described next. At the training phase, object detection can be considered in two separate situations: (i) if the objects are manually selected (such as in a mixed training situation), e.g., already detected, and no further processing is needed for detection; and (ii) if objects of similar classes are presented (e.g., as in batch training process where the objects have similar features (e.g., all red apples or all green apples, etc.)). In the latter case, the objects are detected automatically and separated from the background using feature extraction techniques known to those of skill in the art, e.g., using known object detection algorithms. Another method for object detection for the latter case is to use external triggers that are connected to the system to trigger it to capture objects upon arrival, such as infrared triggers. The computing system 100 can interact with different systems and interface by obtaining the data, sending the data, getting control or trigger signals, or sending control or trigger signals.

In one example, image processing algorithms can be used if the background is of homogeneous texture, intensity, or color that can be easily distinguished from the objects. Such algorithms can include edge detection and contour detection algorithms, or algorithms based on colors and texture segmentation. In a more challenging situation, more advanced classification algorithms can be used for object detection, such as Histogram of Oriented Gradients (HOG), spectral and wavelet methods, and deep learning algorithms, e.g., Yolo and RetinaNet (any of their versions), SPP-Net, Feature Pyramid Networks, Single shot detector (SSD), or Faster R-CNN (or any of its preceding versions). These algorithms can detect objects, even when the background might provide some noise or interference in detecting the object.

Feature extraction is done prior to the classification, which can be conducted by the feature extraction and selection module 115a, in which all feature types are first decided upon and then extracted (using the sensors as described in FIGS. 1A-1E). In this case, the best applicable features are selected in a feature selection phase. The feature selection can be implemented by way of algorithms under filter, wrapper, or embedded methods. Such algorithm include, e.g., forward selection, backward selection, correlation-based feature recursive feature elimination, Lasso, tree-based methods, and genetic algorithm. Also, projection algorithms of the feature selection module 115a can be used for feature reduction such as Principal Component Analysis (PCA), Linear Discriminant Analysis (LDA), Mixture Discriminant Analysis (MDA), Quadratic Discriminant Analysis (QDA), and Flexible Discriminant Analysis (FDA), where features are projected into a lower dimension space. Some algorithms might combine feature extraction and classification, as in deep learning algorithms as should be known in the art such that no further explanation is required.

In embodiments, the extracted features can be classified under the following categories:

(i) Shape features, e.g., size, perimeter, area, chain codes, Fourier descriptors, shape moments;

(ii) Texture features which can be implemented using Local Binary Patterns (LBP), Gabor filter features, Haralick texture feature, and GLCM (GLCM is a histogram of co-occurring greyscale values at a given offset over an image. For example, samples of two different textures can be extracted from a single image), features extracted from GLCM, etc.; and

(iii) Color and intensity features using, e.g., color moments, and color histograms.

In addition to image features, other features can be utilized such as weight, temperature, humidity, depth, point cloud, material composition, and dimensions if taken by, e.g., laser sensors or other sensors.

Also, features and data from external sources can be utilized in training the models and classification, such as weather data, and GPS location, as an illustrative examples. In embodiments, the data from external sources can be used to augment classification capability including weather and GPS data, wherein the data can be used in a training phase or deployment phase.

After feature extraction and selection, a classification model is trained using the classification module (e.g., machine learning) 115b. In embodiments, the classification module 115b can use any multi-class classification algorithms, e.g., logistic regression, decision tree, Support Vector Machines (SVM), Naive Bayes, Gaussian Naive Bayes, k-Nearest Neighbors (kNN), K-Means, Expectation Maximization (EM), reinforcement learning algorithms, Artificial Neural Networks, deep learning algorithms (e.g., Convolutional Neural Networks (CNN), Recurrent Neural Networks (RNNs), Long Short-Term Memory Networks (LSTM), Stacked Auto-Encoders, Deep Boltzmann Machine (DBM), and Deep Belief Networks (DBN), etc. In further embodiments, it is possible to train multiple classifiers using the classification module (e.g., machine learning) 115b, e.g., with different algorithms in an ensemble method.

For example, an ensemble of classifiers can consist of two options, either construct an ensemble consisting of several classifiers of the same type (algorithm) or construct an ensemble consisting of several classifiers of two or more types. Using ensembles usually results in more accurate results. There are several types of ensemble methods, such as bagging and boosting. Examples of such algorithms are random forest, Adaboost, gradient boosting algorithms, XGBoost, and Gradient Boosting Machines (GBM). In embodiments, these methods are used as one classifier for each, where it is possible to stack different classifiers and combine their outputs to obtain the final classification.

In further embodiments, to obtain the final output for ensemble methods, there are different techniques for voting including majority voting and a training voting classifier. In the majority voting, the classification selected is by a majority vote of the classifiers' outputs. In the training voting classifier, it is possible to train a classifier, where its input is the output of different classifiers and its output is the final classification. The types and numbers of stacked classifiers can either be set manually or a search algorithm can select them (but it will take much longer time for training).

In another example, and for illustrative purposes, the training can be a classical approach for machine learning as noted by the previously discussed algorithms. In further embodiments, a deep learning approach for object classification, which can be used either independently, or within an ensemble of various classifiers as described above. As is understood by one of skill in the art, deep learning is a collection of machine learning algorithms based on neural networks; however, training deep learning models need huge amount of data and very powerful machines, and the training takes a very long time (in weeks or months for big models with millions of images in training set).

To account for these shortcomings, the classification module 115b can use several techniques to obtain quicker results based on pre-trained models, such as using transfer learning using available pre-trained models (e.g., on ImageNet, Common Objects in Context (COCO), and Google's Open Images), that can be used as a base model. For objects classification in images, it is contemplated to use Convolutional Neural Networks (ConvNets). ConvNets can be used with transfer learning for object recognition in different ways:

Features extraction: the base model is used as it is, only the classification layer (the final layer in the network is removed). The output of the network without the final layer will give unique features for any input image in a fixed size vector. Using this, it is possible to extract the features for all training images and use them to train a simpler classifier from the previously mentioned machine learning algorithm, such as logistic regression, SVM, decision trees, or random forest.

Fine-tuning: the base model is used but is adapted to the new training dataset. This is done by freezing the whole neural network except the final few layers. Then, during the training, only the non-frozen layers are trained while the remaining of the network is not changing. In this way, it is possible to use the rich features from the training of the millions of images from the base model and adapt the last layers to the specific images in the set. A more specific form is just replacing the final layer responsible of classification with a new layer containing the new number of classes at hand and train the network with the new images.

In further embodiments, a Resnet architecture can be implemented for image classification. Other architectures are also contemplated such as LeNet, AlexNet, VGG, ZFNet, Network in Network, Inception, Xception, ResNet, ResNeXt, Inception-ResNets, DenseNet, FractalNet, CapsuleNet, MobileNet, any of their versions, or any other architectures, by using a pre-trained base classifier for them. Also, detector/classification architectures can be used that combine the detection and classification, such as Yolo and RetinaNet (any of their versions), SPP-Net, Feature Pyramid Networks, Single shot detector (SSD), or Faster R-CNN (or any of its preceding versions). In still further embodiments, more advanced algorithms and techniques for architecture search and Auto ML can be used to find the best architecture and training without hardcoded architecture type and parameters.

The accuracy of each classifier will be calculated on a validation set to assess its performance using, e.g., processor 115. Then the best one (or set of classifiers if using ensemble) will be used. The validation set can be obtained by splitting the training data into training and validation sets, either with a fix proportion (e.g., 60% training and 40% validation, 70%-30%, 80%-20%, or other configurations), or using k-cross-validation, in which the dataset is split into k parts, and the training is conducted k times, each time selecting one part as the validation set and the remaining as the training set, then average the result of the k trained classifiers. In embodiments, an Fn-score is used to assess the accuracy, which is the harmonic mean of precision and recall. Alternatively, it is contemplated to use either precision, recall, specificity, or any other accuracy metrics, such as Area Under ROC (receiver operating characteristic), or a combination of several metrics. In addition to accuracy, the time to classify each sample will be recorded. This will help to make the trade-off between speed and accuracy if the speed is an important factor. The user should specify this, and the system will determine the suitable algorithms based on recorded time and accuracy for each classifier.

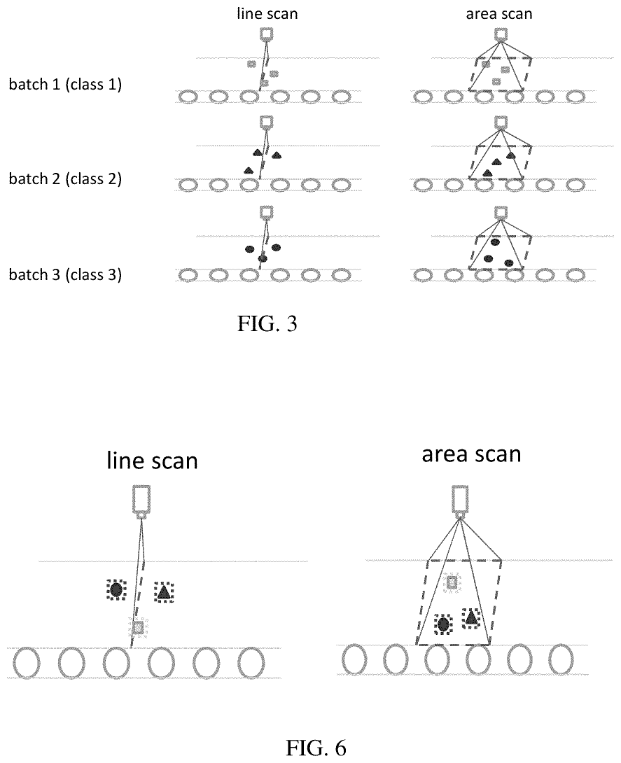

FIG. 3 shows a block diagram using batch training process in accordance with aspects of the present disclosure. More specifically, FIG. 3 shows a batch training process using objects having similar characteristics using either or both a line scan camera and an area camera. In embodiments, FIG. 3 can be representative of a fixed system or a movable system (e.g., camera or other sensor); that is, in FIG. 3, the objects can be moving with respect to a fixed system (e.g., camera or other sensor) or the system (e.g., camera or other sensor) can be moving with respect to the fixed objects.

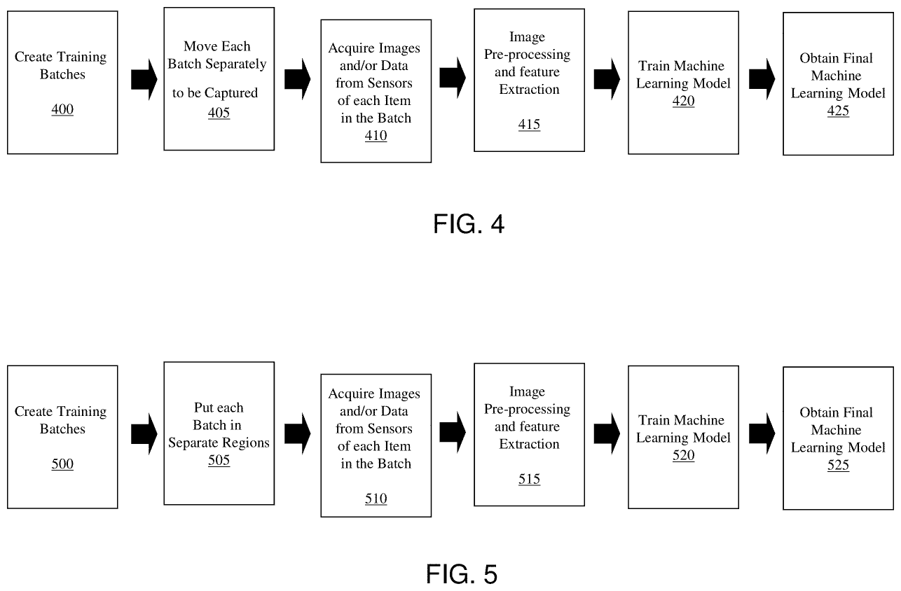

In FIG. 3, the batches of similar objects (objects with similar characteristics) are provided in threes batches of different classes, e.g., objects with characteristics. The number of classed can be two (2) or more according to the specific application. For example, the different characteristics of the objects are, e.g., square (class 1), triangle (class 2) and round (class 3). Other characteristics can be collected through various sensors. It should be understood by those of skill in the art that the characteristics can be representative of any physical characteristic such as, e.g., weight, color descriptors, shape descriptors, texture descriptors, temperature, humidity, depth, point cloud, material composition, etc., as discussed previously. These batches of objects can then be used to train a model for future action on objects of similar characteristics as already noted herein and further described with respect to the flow of FIGS. 4 and 5.

FIG. 4 depicts an exemplary flow using a batch training with a fixed system. Specifically, at step 400, a user will create training batches, with each batch representative of a specific class of objects. For example, in a farming situation, the user may create separate batches of green apples, yellow apples and red apples; although other criteria or characteristics may be used such as weight, size, texture, etc. At step 405, each batch is separately put on a conveyor (or each batch is separately moved past the sensor or camera in some other manner) and, at step 410, the camera will acquire the images for each batch. It should be understood, though, that this step may include obtaining object characteristics (e.g., features) with other sensor types, as described herein. It should be noted also that other situations might arise for the fix system scenario, as fixing the system above streets, or rivers, or any path in which there are moving objects to classify, or fixing the system below moving objects, such as to detect drones or flying birds. The image acquisition also might include segmenting or separating the image from its background before classifying them using various algorithms as described herein. At step 415, the features of the captured images are extracted. The extracted features can include, as in all of the embodiments in a feature selection phase, best applicable features (e.g., unique object characteristics that can be readily discernable or classified). At step 420, the extracted features are used to train a machine learning model. At step 425, after the training, the processes will provide a final machine learning model, which model can now be used to take an action on other objects. Some algorithms might combine feature extraction and classification, as in deep learning algorithms.

FIG. 5 depicts an exemplary flow using a batch training process with a moving system. Specifically, at step 500, a user will create training batches, with each batch representative of an object class. For example, in a farming situation, the user may create separate batches of green apples, yellow apples and red apples; although other criteria or characteristics may be used such as weight, size, texture, etc. At step 505, each batch is placed in a separate area or region. Alternatively, each batch can be identified in a specific region using, e.g., GPS methodologies. At step 510, the camera (or other sensor) will acquire the images (or other characteristics) for each object in the batch at or in the specific area or region. It should be noted that moving body that the system is attached to can comprise many moving systems, such as any vehicle, drone, or moving robot (bi-pedal, 4, 6, or 8 legged robots, robots on tires, robotic arm, etc.), or handheld device of any type, e.g., phone or tablet.

The image acquisition might include segmenting the image from its background before classifying them using various algorithms as described herein. At step 515, the features of the captured images are extracted. At step 520, the extracted features are used to train a machine learning model. At step 525, after the training, the processes will provide a final machine learning model, which model can now be used to take an action on other objects. Some algorithms might combine feature extraction and classification, as in deep learning algorithms.

FIG. 6 shows a block diagram using mixed training process in accordance with aspects of the present disclosure. In embodiments, FIG. 6 can be representative of a fixed system or a movable system (e.g., camera or other sensor); that is, in FIG. 6, the objects can be moving with respect to a fixed system (e.g., camera or other sensor) or the system (e.g., camera or other sensor) can be moving with respect to the fixed objects.

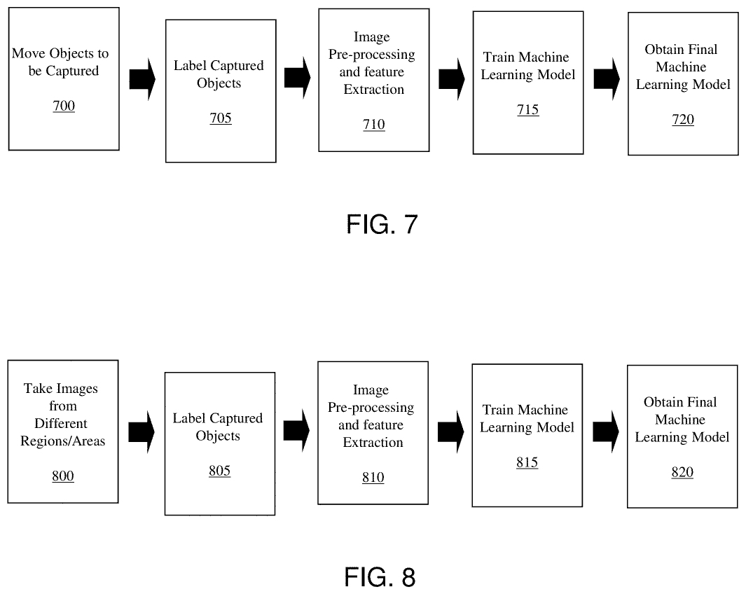

More specifically, FIG. 6 shows a mixed training process using objects having dissimilar characteristics using either or both a line scan camera and an area camera. In FIG. 6, the batches of dissimilar objects are labeled by the operator as they are imaged, e.g., train on the objects. Alternatively, the images and data are saved and labeled off-line by the operator. The labeling process might also be done on either on a local machine, a machine in the local network, a remote server, or the cloud, by the operator(s) or other party. As in any of the scenarios, it should be understood that the more training performed, e.g., labeling, the better the set will be for honing in on the different subtleties that there might be in order to use it in the deployment stage. These objects can then be used to train a model for future action on objects of similar characteristics as already noted herein and further described with respect to the flow of FIGS. 7 and 8.

FIG. 7 depicts an exemplary flow using a mixed training process with a fixed system in accordance with aspects of the present disclosure. Specifically, at step 700, the objects are placed on a conveyor by the user; although as discussed previously, the system can be installed in settings other than conveyor situation. For example, the objects can be moved separately moved past the sensor or camera in some other manner. In this example, the objects are of a mixed nature, e.g., having different characteristics. At step 705, the objects are imaged and/or reading from sensors are taken, the operator (user) will label the captured objects, e.g., train on the objects. It is also contemplated to label data other than images that came from the sensor or other sources. Alternatively, the images or other characteristics can be saved and then labeled offline, either by the operators or by other party as discussed previously. At step 710, the features of the captured images are extracted. At step 715, the extracted features are used to train a machine learning model. At step 720, after the training, the processes will provide a final machine learning model, which model can now be used to take an action on other objects. Some algorithms might combine feature extraction and classification, as in deep learning algorithms.

FIG. 8 depicts an exemplary flow using a mixed training process with a moving system in accordance with aspects of the present disclosure. Specifically, at step 800, images of the objects (or other characteristics) are obtained from different regions or areas by a moving sensor. In this example, again, the objects are of a mixed nature, e.g., having different characteristics. At step 805, as the objects are imaged and/or reading from sensors are taken, the operator (user) will label the captured objects. Alternatively, the images or other characteristics can be saved and then labeled offline, either by the operators or by other party as discussed previously. The image acquisition can include segmenting the image from its background before classifying them using various algorithms as described herein. At step 810, the features of the captured images are extracted. At step 815, the extracted features are used to train a machine learning model. At step 820, after the training, the processes will provide a final machine learning model, which model can now be used to take an action on other objects. Some algorithms might combine feature extraction and classification, as in deep learning algorithms.

As should now be understood, FIGS. 4, 5, 7 and 8 depict an exemplary flow for a process in accordance with aspects of the present disclosure. The exemplary flow can be illustrative of a system, a method, and/or a computer program product and related functionality implemented on the computing system of FIG. 2, in accordance with aspects of the present disclosure. The computer program product may include computer readable program instructions stored on computer readable storage medium (or media). The computer readable storage medium includes the one or more storage medium as described with regard to FIG. 2, e.g., non-transitory media, a tangible device, etc. The method, and/or computer program product implementing the flow of FIG. 4 can be downloaded to respective computing/processing devices, e.g., computing system of FIG. 2 as already described herein, or implemented on a cloud infrastructure as described with regard to FIG. 2. The machine learning model training and deployment can be done either locally or remotely. The system on-site can consist of edge devices, PCs, and any type of workstations or computing machines. Remote infrastructure might include remote servers or cloud infrastructures, as examples. And, in embodiments, the system can be trained on premise at the edge device, personal computer, workstation, or other computation device, as well as trained on a remote servers/workstations or cloud infrastructure.

The foregoing examples have been provided merely for the purpose of explanation and are in no way to be construed as limiting of the present disclosure. While aspects of the present disclosure have been described with reference to an exemplary embodiment, it is understood that the words which have been used herein are words of description and illustration, rather than words of limitation. Changes may be made, within the purview of the appended claims, as presently stated and as amended, without departing from the scope and spirit of the present disclosure in its aspects. Although aspects of the present disclosure have been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A method comprising:
extracting, using a computing device, features of a plurality of objects;
training, using the computing device, a machine learning model with selected ones of the extracted features;
building, using the computing device, a final machine learning model of the selected features after all of the plurality of objects for training are captured; and
performing, using the computing device, an action on subsequent objects based on their characteristics matching the selected features in the final machine learning model.

2. The method of claim 1, further comprising capturing the features using a sensor or plurality of sensors, wherein the selected features are similar characteristics in a batch of objects.

3. The method of claim 1, wherein the training is a batch training process comprising training on a plurality of similar objects in a batch of objects, at a single time and on-site of where the action is performed by a same or another machine.

4. The method of claim 3, wherein the batch training process comprising acquiring images and/or data from sensors of each object in the batch of objects from a specified region using a moving camera or sensor, wherein the selected features are extracted from the images.

5. The method of claim 1, further comprising capturing the features using a sensor, wherein the selected features are a mix of different objects with different features.

6. The method of claim 5, wherein the training is a mixed training process with a mix of different object classes, which includes manually labeling the objects after they are captured to use them for training.

7. The method of claim 1, further comprising, after finishing the training, validating results of the final machine learning model on new objects that were not previously captured.

8. The method of claim 1, wherein the features are captured by a fixed or moving sensor which captures the features of the plurality of objects.

9. The method of claim 1, wherein, at the training, the plurality of objects may be separated from their background using image processing techniques, before extracting features and classifying of the plurality of objects using the features.

10. The method of claim 1, wherein the training uses multi-class classification algorithms.

11. The method of claim 1, wherein the training is implemented with a single classifier or an ensemble of classifiers.

12. A system comprising:
a processor, a computer readable memory, one or more computer readable storage media, and program instructions collectively stored on the one or more computer readable storage media, the program instructions executable to:
receive captured images, data, and features of a plurality of objects from a sensor;
extract selected features from the captured images;
train a machine learning model with the selected captured and extracted features;
build a final machine learning model of the selected features after training from the plurality of objects is completed; and
perform an action on subsequent objects based on the trained final machine learning model.

13. The system of claim 12, wherein the action to be performed in a classifying of the subsequent objects based on the trained final machine learning model.

14. The system of claim 12, wherein the training use pre-trained deep learning models including using feature extraction and transfer learning.

15. The system of claim 12, wherein the system is trained on premise at an edge device, personal computer, workstation, or other computation device.

16. The system of claim 12, wherein the system is trained on a remote servers/workstations or cloud infrastructure.

17. The system of claim 12, wherein the program instructions are executable to provide detection, segmentation, features extraction and selection, and classification, directly on an edge device, on a device in the local network, or on a remote device in a remote network or on the cloud.

18. The system of claim 12, wherein the program instructions are executable to directly switch between training and deployment of an operation mode, to immediately be used after training.

19. The system of claim 12, further comprising manually labeling features of the objects which have different characteristics on-site or off-site, either by operators or another party.

20. The system of claim 12, wherein the captured images are captured by image capturing devices, including at least one of gray scale cameras, color cameras, multi-spectral cameras, hyper-spectral cameras, thermal cameras, X ray imaging, and ultrasound imaging.

21. The system of claim 12, wherein the capturing is performed by sensors to capture desired characteristic of the objects including images, size, aspect ratio, color, reflectance, perimeter, texture, weight, temperature, humidity, and/or material composition.

22. The system of claim 12, further comprising using data from external sources to augment classification capability including weather and GPS data wherein the data is used in a training phase or deployment phase.

23. The system of claim 12, further comprising actuators for actions to be performed on the objects after the training.

24. The system of claim 12, wherein the actions are programmatically provided by saving to a database or sending alerts, triggers, or commands to another system.

25. The system of claim 12, further comprising interacting with different systems and interfaces by obtaining the data, sending the data, getting control or trigger signals, or sending control or trigger signals.

26. The system of claim 12, wherein the system is either installed in a fixed location or on moving bodies.

27. The system of claim 26, wherein the fixed system is fixed on top of a way that has moving objects or below a way having the moving objects.

28. The system of claim 27, further comprising capturing the data using a moving system attached to moving bodies including any vehicle, drone, or robot.

29. The system of claim 12, further comprising handheld devices which contain the system or is part of the system.

30. The system of claim 12, wherein the objects to be classified are fixed or moving objects.

31. The system of claim 12, wherein single or multiple features are used to classify the objects. and the classification is provided by using a single classifier or an ensemble of classifiers.

32. The system of claim 31, further comprising manually configured classifier algorithms, or automatic algorithms selected from classifiers based on accuracy and speed.

33. The system of claim 12, wherein the images and/or data are captured using a single camera, multiple cameras, a single sensor or multiple sensors, or combination thereof.

34. The system of claim 12, further comprising at a camera, sensors, storage, processing, and computation units, which are gathered in one enclosure or developed into separate modules that are connected within a same location or distributed into many locations.
